(19) United States
(12) Patent Application Publication
(10) Pub. No.: US 2017/0300148 A1
(43) Pub. Date: Oct. 19, 2017

(54) CAPACITANCE MEASUREMENT CIRCUIT

(71) Applicant: ROHM CO., LTD., Ukyo-Ku (JP)

(72) Inventor: Yuji SHIMADA, Ukyo-Ku (JP)

(21) Appl. No.: 15/486,715

(22) Filed: Apr. 13, 2017

(30) Foreign Application Priority Data
Apr. 14, 2016 (JP) 2016-080864

(51) Int. Cl. G06F 3/044

(52) U.S. Cl. CPC G06F 3/044

(57) ABSTRACT

A capacitance measurement circuit measures each of multiple electrostatic capacitances. Charger circuits respectively correspond to a sensor capacitance Cs. Each charger circuit charges the corresponding sensor capacitance Cs so as to generate a detection current Is that corresponds to a charging current I_{CHG}. A current averaging circuit is configured to be switchable between the on state and the off state. In the on state, the current averaging circuit outputs an average current I_{AVE} obtained by averaging the detection currents Is generated by the multiple charger circuits. In the off state, the current averaging circuit outputs an average current I_{AVE} of zero. The capacitance measurement circuit measures each sensor capacitance Cs based on a differential current between the corresponding detection current Is and the average current I_{AVE}.

### CROSS-REFERENCE TO RELATED APPLICATIONS

This application is based upon and claims the benefit of priority from the prior Japanese Patent Application No. 2016-080864, filed Apr. 14, 2016, the entire contents of which are incorporated herein by reference.

### BACKGROUND OF THE INVENTION

### 1. Field of the Invention

The present invention relates to an electrostatic capacitance measurement apparatus.

### 2. Description of the Related Art

In recent years, various kinds of electronic devices such as computers, smartphones, tablet terminals, portable audio devices, and the like include a touch-type input apparatus mounted as a user interface. Known examples of such a touch-type input apparatus include touch pads, pointing devices, and the like. By operating such a touch-type input apparatus by touch or otherwise by proximity with a finger or stylus, such an arrangement allows the user to perform various kinds of input operations.

The methods employed in such touch-type input apparatuses can be classified into two principal methods, i.e., a resistive film method and an electrostatic capacitance method. With the electrostatic capacitance method, when the user performs an input operation, this leads to a change in the electrostatic capacitances (which will simply be referred to as the “capacitances” hereafter) formed by the multiple sensor electrodes. By converting such a change in the electrostatic capacitance into an electric signal, such an arrangement is capable of detecting the presence or absence, as well as the coordinate position, of user input.

A touch panel is configured including multiple sensor electrodes. An X-Y matrix touch panel includes row sensor electrodes each of which is assigned to a corresponding matrix row, and column sensors each of which is assigned to a corresponding matrix column. By detecting respective changes in the capacitance of the multiple sensor electrodes, such an arrangement is capable of identifying a coordinate position touched by the user.

With conventional techniques, typically, a capacitance detection circuit detects the capacitance of each of the multiple sensor electrodes in a time sharing manner. For example, with the aforementioned X-Y matrix touch panel, the capacitance is sequentially detected for each of the multiple column sensors. Furthermore, the capacitance is sequentially detected for each of the multiple row sensors. With such a method, there is a difference between the respective sensor electrodes in the timing at which the capacitance is detected. This leads to a difference in noise effects between the respective sensor electrodes, which is a problem.

### SUMMARY OF THE INVENTION

The present invention has been made in order to solve such a problem. Accordingly, it is an exemplary purpose of an embodiment of the present invention to provide a capacitance measurement circuit that is capable of detecting the capacitance values of the multiple sensor electrodes at the same time, or of individually detecting the capacitance of each sensor electrode.

An embodiment of the present invention relates to a capacitance measurement circuit structured to measure multiple electrostatic capacitances. The capacitance measurement circuit comprises multiple analog frontend circuits. Each of the multiple analog frontend circuits comprises: a sensing terminal to be coupled to a corresponding electrostatic capacitance; a first transistor arranged between the corresponding electrostatic capacitance and a first fixed voltage line; a second transistor and a third transistor coupled so as to form, together with the first transistor, a first current mirror circuit; a fourth transistor arranged between the third transistor and a second fixed voltage line; and a fifth transistor coupled between the second transistor and the second fixed voltage line so as to form, together with the fourth transistor, a second current mirror. Each of the analog frontend circuits is structured to generate a signal that corresponds to a difference between a current that flows through the first transistor and a current that flows through the fifth transistor. Control terminals of the fourth transistors and control terminals of the fifth transistors of the multiple analog frontend circuits are coupled so as to form a common control terminal. The operation mode is switchable between: (i) a first mode in which a current flows through each of the first transistor through the fifth transistor; and (ii) a second mode in which a current flows through each of the first transistor and the second transistor, and no current flows through the fifth transistor.

In the first mode, the average current of the multiple detection currents flows through the fifth transistor included in each analog frontend circuit. Accordingly, in the first mode, such an arrangement is capable of detecting the difference between each electrostatic capacitance and the overall electrostatic capacitance, i.e., a relative change in each electrostatic capacitance. In contrast, in the second mode, the current that flows through the fifth transistor is set to zero. Accordingly, in the second mode, such an arrangement is capable of detecting each electrostatic capacitance.

Also, each of the analog frontend circuits may further comprise a first mode switch arranged in parallel with the fourth transistor. When the first mode switch is turned on, the current that flows through the fourth transistor is set to zero, which sets the operation mode to the second mode.

Also, each of the analog frontend circuits may further comprise a second mode switch arranged between the second fixed voltage line and the common control terminal of the fourth transistor and the fifth transistor. When the second mode switch is turned on, the fourth transistor and the fifth transistor are turned off, which sets the operation mode to the second mode.

Also, each of the analog frontend circuits may further comprise: a third mode switch arranged between a common control terminal of the first transistor and the second transistor and a control terminal of the third transistor; and a fourth mode switch arranged between the control terminal of the third transistor and the first fixed voltage line. When the third mode switch is turned off, and the fourth mode switch is turned on, the third transistor is turned off, which sets the operation mode to the second mode.

Also, each of the analog frontend circuits may further comprise: a sensing switch structured to switch, between an on state and an off state, a charging operation of the first transistor for charging the electrostatic capacitance; and an initializing switch arranged between the sensing terminal and the second fixed voltage line. Also, the sensing switch may be arranged in series with the first transistor between the sensing terminal and the first fixed voltage line.

Also, each of the analog frontend circuits may further comprise: a bypass switch having one end coupled to the sensing terminal; and an integrating circuit having an input terminal coupled to the second transistor and the other end of the bypass switch, and structured to integrate a current input via the input terminal so as to generate a detection voltage.

Also, the integrating circuit may comprise: an operational amplifier; an integrating capacitor arranged between an output terminal and an inverting input terminal of the operational amplifier; and a feedback resistor coupled in parallel with the integrating capacitor.

Another embodiment of the present invention also relates to a capacitance measurement circuit structured to measure multiple electrostatic capacitances. The capacitance measurement circuit comprises: multiple charger circuits that are respectively associated with the multiple electrostatic capacitances, and each of which is structured to charge the corresponding electrostatic capacitance so as to generate a detection current that corresponds to a charging current; and a current averaging circuit structured to be switchable between: an on state in which the current averaging circuit outputs an average current obtained by averaging the detection currents generated by the multiple charger circuits; and an off state in which the current averaging circuit outputs an average current of zero. Each electrostatic capacitance is measured based on a differential current between the corresponding detection current and the average current.

In the first mode, each detection current corresponds to the electrostatic capacitance of the corresponding sensor capacitance. The average current corresponds to the average value of the electrostatic capacitances of the multiple sensor capacitances. Accordingly, in the first mode, such an arrangement is capable of detecting the difference between the sensor capacitance of each channel and the average capacitance over all the channels, i.e., of detecting a relative change in the capacitance for each channel. On the other hand, in the second mode, the average current is set to zero. Accordingly, such an arrangement is capable of detecting the sensor capacitance for each channel.

Also, the charger circuit may comprise: a reset switch structured to initialize a charge stored in the corresponding electrostatic capacitance; a sensing switch and a first transistor configured as a MOSFET, which are sequentially arranged in series between the corresponding electrostatic capacitance and a fixed voltage terminal; and a second transistor coupled to the first transistor so as to form a first current mirror circuit. A current that flows through the second transistor may be output as the detection current that corresponds to the corresponding electrostatic capacitance.

Also, the current averaging circuit may comprise: multiple third transistors that are respectively associated with the multiple electrostatic capacitances, and each of which is coupled to a corresponding first transistor so as to form a current mirror circuit; multiple fourth transistors that are respectively associated with the multiple electrostatic capacitances, and that have control terminals coupled so as to form a common control terminal, and each of which is arranged in series with the corresponding third transistor; and multiple fifth transistors that are respectively associated with the multiple electrostatic capacitances, and each of which is coupled to a corresponding fourth transistor so as to form a current mirror circuit. Also, currents that flows through the multiple fifth transistors may each be output as the average current.

Also, the capacitance measurement circuit may further comprise multiple first mode switches that are respectively associated with the multiple electrostatic capacitances, and each of which is coupled in parallel with a corresponding fourth transistor.

Also, the capacitance measurement circuit may further comprise multiple second mode switches that are respectively associated with the multiple electrostatic capacitances, and each of which is arranged between a gate of the corresponding fourth transistor and a ground.

Also, the current averaging circuit may comprise: multiple third mode switches that are respectively associated with the multiple electrostatic capacitances, and each of which is arranged between a common control terminal of the corresponding first transistor and the corresponding second transistor and a control terminal of the corresponding third transistor; and multiple fourth mode switches that are respectively associated with the multiple electrostatic capacitances, and each of which is arranged between the control terminal of the corresponding third transistor and a power supply line.

Also, each of the multiple fifth transistors may have one end coupled to one terminal of the corresponding second transistor. Also, a difference between a current that flows through the second transistor and a current that flows through the fifth transistor may be output.

Also, the capacitance measurement circuit may monolithically be integrated on a single semiconductor substrate. Examples of such a “monolithically integrated” arrangement include: an arrangement in which all the circuit components are formed on a semiconductor substrate; and an arrangement in which principal circuit components are monolithically integrated. Also, a part of the circuit components such as resistors and capacitors may be arranged in the form of components external to such a semiconductor substrate in order to adjust the circuit constants. By monolithically integrating the circuit on a single chip, such an arrangement allows the circuit area to be reduced, and allows the circuit elements to have uniform characteristics.

Yet another embodiment of the present invention relates to an input apparatus. The input apparatus may comprise: a touch panel comprising multiple sensor electrodes structured such that electrostatic capacitances thereof change in the vicinity of a coordinate position at which a user touches the touch panel; and any one of the aforementioned capacitance measurement circuits structured to measure the multiple electrostatic capacitances formed by the multiple sensor electrodes.

Yet another embodiment of the present invention relates to an electronic device. The electronic device may comprise the aforementioned input apparatus.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram showing a configuration of an electronic device including an input apparatus according to an embodiment;

FIG. 2 is a block diagram showing a configuration of a control IC according to the embodiment;

FIG. 3 is a circuit diagram showing a specific example configuration of a control IC;

FIGS. 4A and 4B are circuit diagrams each showing an AFE circuit configured to be capable of switching its operation mode;

FIG. 5 is a waveform diagram showing the operation of the control IC in a first mode according to the embodiment;

FIG. 6 is a waveform diagram showing the operation of the control IC in a second mode according to the embodiment;

FIG. 7 is a circuit diagram showing an application of the control IC;

FIGS. 8A through 8C are operation waveform diagrams each showing the operation of an input apparatus shown in FIG. 7;

FIG. 9 is a circuit diagram showing a modification of a capacitance measurement circuit; and

FIG. 10 is an operation waveform diagram showing the operation of the capacitance measurement circuit in a third mode.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is coupled to the member B” includes a state in which the member A is indirectly coupled to the member B via another member that does not substantially affect the electric connection therebetween, or that does not damage the functions or effects of the connection therebetween, in addition to a state in which the member A is physically and directly coupled to the member B.

Similarly, the state represented by the phrase “the member C is provided between the member A and the member B” includes a state in which the member A is indirectly coupled to the member C, or the member B is indirectly coupled to the member C via another member that does not substantially affect the electric connection therebetween, or that does not damage the functions or effects of the connection therebetween, in addition to a state in which the member A is directly coupled to the member C, or the member B is directly coupled to the member C.

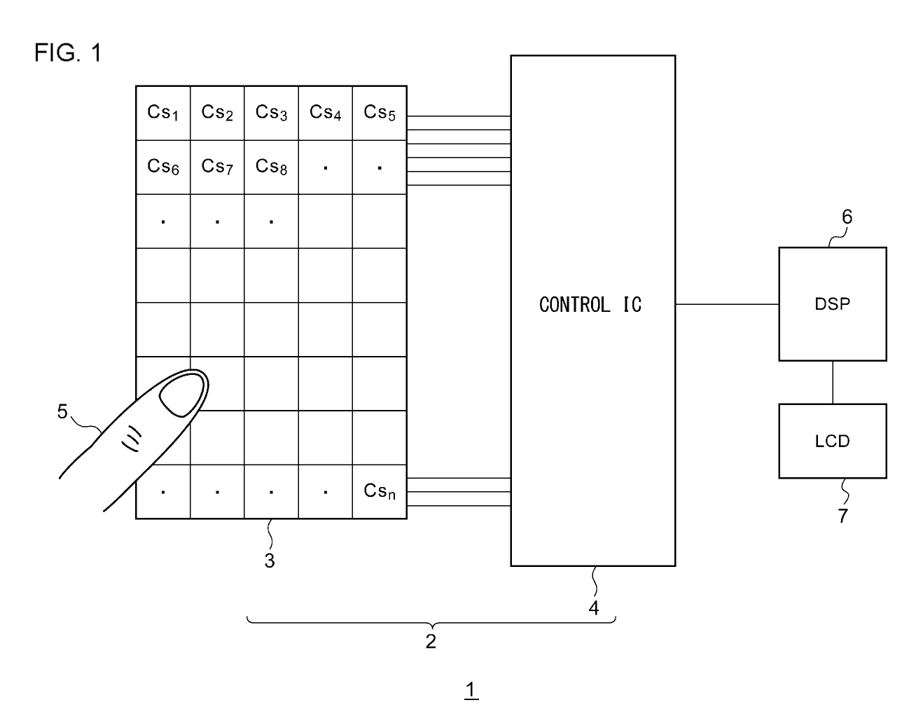

FIG. 1 is a diagram showing a configuration of an electronic device 1 including an input apparatus 2 according to an embodiment. The electronic device 1 includes a DSP (Digital Signal Processor) 6 and an LCD (Liquid Crystal Display) 7 in addition to the input apparatus 2. The input apparatus 2 includes a touch panel 3 and a control IC 4. The touch panel 3 includes multiple sensor capacitances Cs₁ through Csₙ in a regular manner. Specifically, the multiple sensor capacitances Cs₁ through Csₙ are substantially arranged in a matrix form. The control IC 4 is coupled to each of the multiple sensor capacitances Cs₁ through Csₙ. The control IC 4 detects the electrostatic capacitance of each sensor capacitance Cs, and outputs the data that represents the capacitance values thus detected to the DSP 6.

When the user of the electronic device 1 touches the touch panel 3 with a finger 5 or otherwise a stylus, this leads to a change in the electrostatic capacitance of the sensor capacitance Cs at the coordinate position the user has touched. The DSP 6 detects the coordinate position at which the user has touched, based on the electrostatic capacitances of the multiple sensor capacitances Cs. For example, the touch panel 3 may be mounted on the surface of the LCD 7. Also, the touch panel 3 may be arranged at other locations.

The above is the overall configuration of the electronic device 1. Next, detailed description will be made regarding the input apparatus 2.

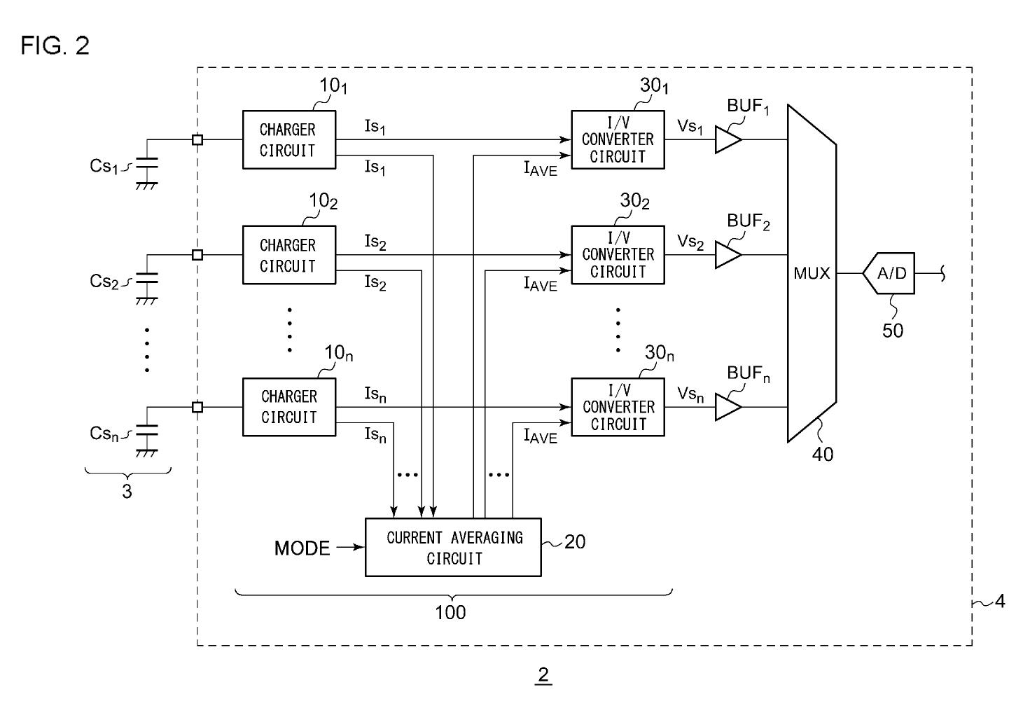

FIG. 2 is a block diagram showing a configuration of the control IC 4 according to the embodiment. The control IC 4 includes a capacitance measurement circuit 100, a multiplexer 40, and an A/D converter 50, which are integrated on a single semiconductor substrate. Also, a part of the functions of the DSP 6 may be implemented in the control IC 4.

The capacitance measurement circuit 100 measures the electrostatic capacitance for each of the multiple sensor capacitances Cs₁ through Csₙ using a so-called self-capacitance method. For example, the capacitance measurement circuit 100 generates a detection voltage Vs that corresponds to each electrostatic capacitance. Buffer units BUF1 through BUFn receive the detection voltages Vs₁ through Vsₙ, and output the detection voltages Vs₁ through Vsₙ to the multiplexer 40. The multiplexer 40 sequentially selects the multiple detection voltages Vs₁ through Vsₙ in a time sharing manner. The A/D converter 50 sequentially converts the detection voltages Vs thus selected by the multiplexer 40 into digital values D_{OUT}.

The capacitance measurement circuit 100 includes multiple charger circuits 10₁ through 10ₙ, a current averaging circuit 20, and multiple integrating circuits 30₁ through 30ₙ.

The charger circuits 10₁ through 10ₙ are provided for the sensor capacitances Cs₁ through Csₙ, respectively. Each charger circuit 10ᵢ (1≦i≦n) generates a detection current Isᵢ that corresponds to the corresponding sensor capacitance Csᵢ, and outputs the detection current Isᵢ thus generated to the corresponding integrating circuit 30ᵢ and the current averaging circuit 20.

The current averaging circuit 20 is configured to be switchable between the on state and the off state. In the on state, the current averaging circuit 20 averages the detection currents Is₁ through Isₙ generated by the multiple charger circuits 10₁ through 10ₙ. The detection current (which will also be referred to as the “average current” hereafter) I_{AVE} thus obtained by averaging is supplied to each of the multiple integrating circuits 30₁ through 30ₙ.

I_{AVE}=Σ_{i=1:n}Isᵢ/n (1a)

In the off state, the current averaging circuit 20 generates an average current I_{AVE} of zero.

I_{AVE}=0 (1b)

The current averaging circuit 20 receives, as an input signal, a mode control signal MODE that indicates the mode. When the mode control signal MODE indicates a first mode, the current averaging circuit 20 is set to the on state. On the other hand, when the mode control signal MODE indicates a second mode, the current averaging circuit 20 is set to the off state.

The capacitance measurement circuit 100 outputs, for each sensor capacitance Cs, a signal that corresponds to a differential current I_{DIFFi} (Isᵢ−I_{AVE}) which is the difference between the detection current Isᵢ and the average current I_{AVE}.

The multiple integrating circuits 30₁ through 30ₙ are provided for the sensor capacitances Cs₁ through Csₙ, respectively. Each integrating circuit 30ᵢ converts the corresponding differential current I_{DIFFi} (=Isᵢ−I_{AVE}) into a voltage, and outputs the voltage thus converted as the detection voltage Vsᵢ. Each integrating circuit 30 can also be regarded as a current/voltage converter (I/V converter) circuit.

The above is the configuration of the capacitance measurement circuit 100.

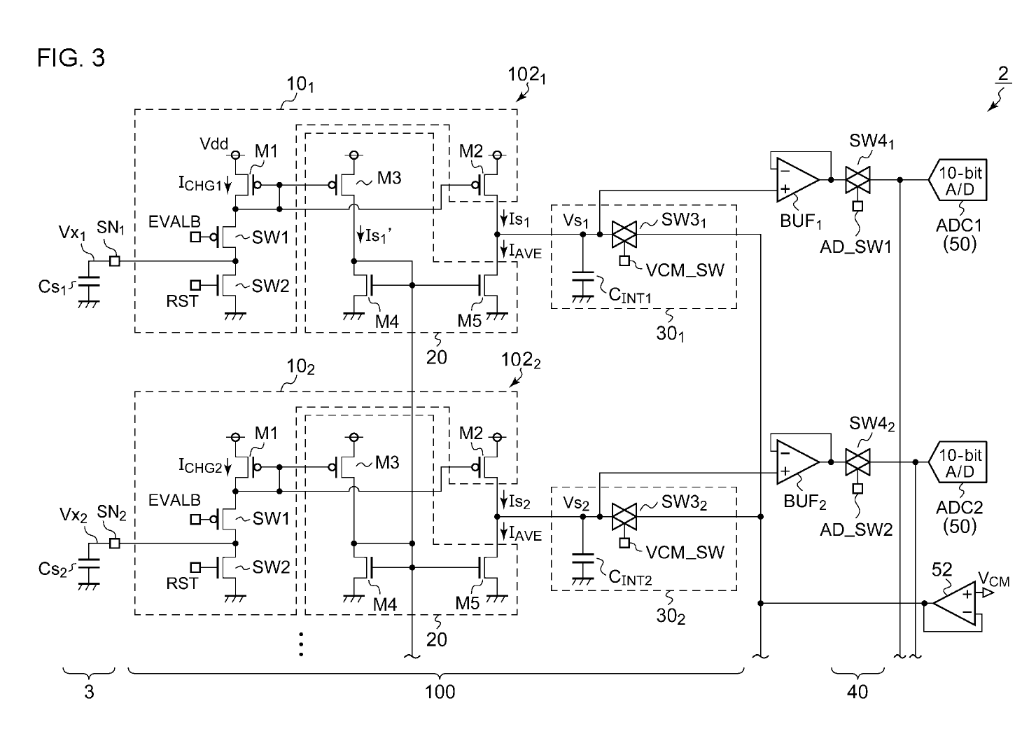

FIG. 3 is a circuit diagram showing a specific example configuration of the control IC 4. FIG. 3 shows only a part of the control IC 4 that corresponds to the sensor capacitances Cs₁ and Cs₂. The capacitance measurement circuit 100 includes multiple AFE circuits 102₁ through 102ₙ. Each AFE circuit 102 is arranged such that it is associated with a corresponding sensor capacitance Cs.

The multiple AFE circuits 102 have the same configurations. Accordingly, description will be made regarding the configuration of the AFE circuit 102 with reference to a single AFE circuit of a given channel as a representative example.

Each AFE circuit 102ᵢ includes the corresponding charger circuit 10ᵢ and a part of the current averaging circuit 20. Each sensing terminal SENSEᵢ is coupled to the corresponding electrostatic capacitance Csᵢ. Each charger circuit 10ᵢ includes a sensor switch (sensing switch) SW1, an initializing switch (reset switch) SW2, a first transistor M1, and a second transistor M2.

The sensing switch SW1 and the first transistor M1 are sequentially arranged in series between the sensor capacitance Cs and a first fixed voltage line (in this example, a power supply line). The sensing switch SW1 is configured as a P-channel MOSFET. A sensing signal EVALB is input to the gate of the sensing switch SW1. When the sensing signal EVALB is asserted (set to the low level), the sensing switch SW1 is turned on.

The initializing switch SW2 is provided in order to allow the charge stored in the corresponding sensor capacitance Cs to be initialized. For example, the initializing switch SW2 is arranged in parallel with the sensor capacitance Cs. When the initializing switch SW2 is turned on, the charge stored in the sensor capacitance Cs is discharged, thereby initializing the sensor capacitance Cs. That is to say, in this state, the voltage difference becomes zero across both ends of the sensor capacitance Cs. For example, the initializing switch SW2 includes an N-channel MOSFET arranged such that a reset signal RST is input to its gate. When the reset signal RST is asserted (set to the high level), the initializing switch SW2 is turned on.

The first transistor M1 is configured as a P-channel MOSFET. Specifically, the drain of the first transistor M1 is coupled to the sensor capacitance Cs via the sensing switch SW1. The source of the first transistor M1 is coupled to the power supply terminal. Furthermore, the gate and the drain of the first transistor M1 are coupled to each other. A charging current I_{CHGi} flows through the first transistor M1 according to the capacitance value of the corresponding sensor capacitance Csᵢ.

The second transistor M2 is configured as a P-channel MOSFET of the same type as that of the first transistor M1. The second transistor M2 is coupled to the first transistor M1 such that they form a current mirror circuit. Specifically, the gate of the second transistor M2 is coupled to the gate of the first transistor M1. Furthermore, the source of the second transistor M2 is coupled to the power supply terminal. A detection current Is flows through the second transistor M2 according to the capacitance value of the corresponding sensor capacitance Cs. With the mirror ratio (size ratio) between the first transistor M1 and the second transistor M2 as K1, the detection current Isᵢ, is represented by the following Expression (2).

Isᵢ=I_{CHGi}×K1 (2)

Each AFE circuit 102₁, includes a third transistor M3 through a fifth transistor M5, which correspond to the current averaging circuit 20.

The third transistor M3 is configured as a MOSFET of the same type as that of the first transistor M1. The third transistor M3 is coupled to the corresponding first transistor M1 so as to form a current mirror circuit, which generates a current Is′ that corresponds to the corresponding detection current Is. The fourth transistor M4 is arranged between the third transistor M3 and the second fixed voltage line (ground line), i.e., on a path of the current Is′. The fourth transistor M4 is arranged such that its gate and its drain are coupled to each other.

The fifth transistor M5 is coupled between the second transistor M2 and the second fixed voltage line (ground line), so as to form, together with the fourth transistor M4, a second current mirror circuit. In each of the multiple AFE circuits 102, the fourth transistor M4 and the fifth transistor M5 are arranged such that their control terminals (gates) are coupled to each other so as to form a common control terminal. The average current I_{AVE}, which is obtained by averaging the detection currents Is₁ through Is of all the channels, flows through the fifth transistor M5.

Each AFE circuit 102 outputs a current, which corresponds to the difference between the current Isᵢ that flows through the first transistor M1 and the current I_{AVE} that flows through the fifth transistor M5, to the corresponding integrating circuit 30 configured as a downstream stage. That is to say, when Isᵢ>I_{AVE}, the AFE circuit 102 supplies a current (in the form of a source current) to the corresponding integrating circuit 30ᵢ. Conversely, when Isᵢ<I_{AVE}, the AFE circuit 102 draws a current (in the form of a sink current) from the corresponding integrating circuit 30ᵢ.

Each AFE circuit 102 is configured to be switchable between (i) the first mode in which a current flows through each of the first transistor M1 through the fifth transistor M5 and (ii) the second mode in which a current flows through each of the first transistor M1 and the second transistor M2, and current does not flow through the fifth transistor M5. As described above, the current averaging circuit 20 enables switching between the first mode and the second mode.

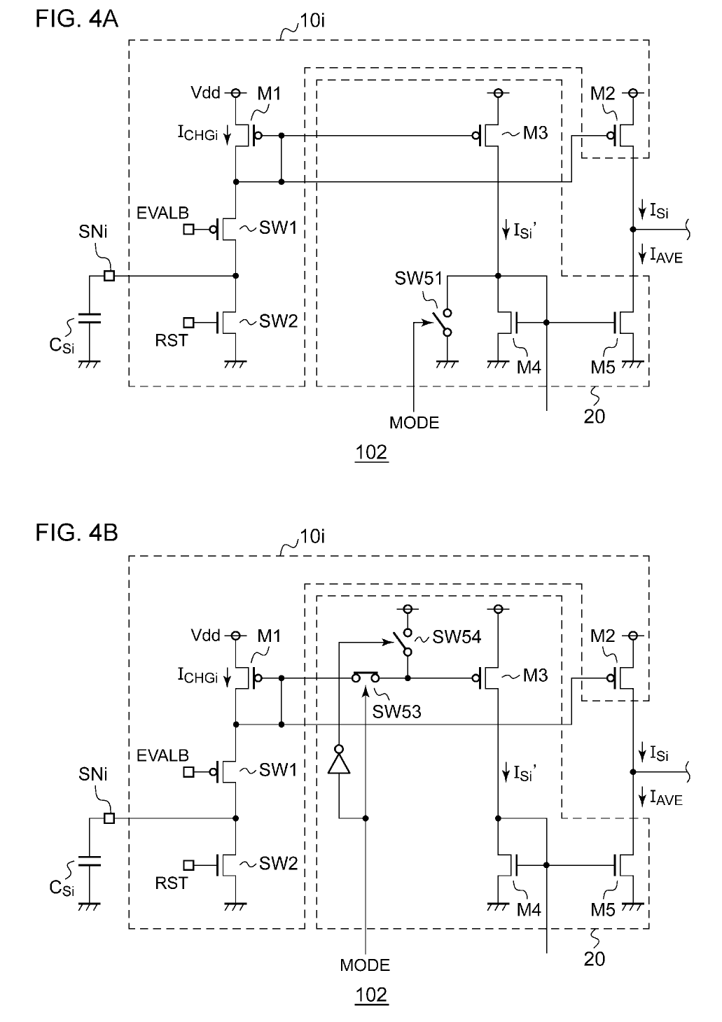

FIGS. 4A and 4B are circuit diagrams each showing the AFE circuit 102 that is capable of switching the mode. In FIG. 4A, the current averaging circuit 20 includes a first mode switch SW51 arranged in parallel with the fourth transistor M4. The first mode switch SW51 can also be regarded as a second mode switch arranged between the common gate and the common source of the fourth transistor M4 and the fifth transistor M5.

The first mode switch SW51 is controlled according to the mode control signal MODE. When the first mode switch SW51 is turned off, the average current I_{AVE} becomes the average of the detection currents Is₁ through Is of all the channels. Accordingly, in this state, the mode is set to the first mode. Conversely, when the first mode switch SW51 is turned on, the operation of the current mirror circuit formed of the transistors M4 and M5 stops, which sets the average current I_{AVE} to zero.

The current averaging circuit 20 shown in FIG. 4B includes a third mode switch SW53 and a fourth mode switch SW54.

The third mode switch SW53 is arranged between the common control terminal (gate) of the first transistor M1 and the second transistor M2 and the control terminal (gate) of the third transistor M3. The fourth mode switch SW54 is arranged between the control terminal (gate) of the third transistor M3 and the first fixed voltage line (power supply line), i.e., between the gate and the source of the third transistor M3.

The third mode switch SW53 and the fourth mode switch SW54 are controlled according to the mode control signal MODE. When the third mode switch SW53 is turned on and the fourth mode switch SW54 is turned off, the current mirror circuit including the first transistor M1 through the third transistor M3 becomes operable, which sets the mode to the first mode. Conversely, when the third mode switch SW53 is turned off and the fourth mode switch SW54 is turned on, the third transistor M3 becomes OFF. In this state, the current Isᵢ′ becomes zero, and the average current I_{AVE} that flows through the fifth transistor M5 becomes zero, which sets the mode to the second mode.

It can be clearly understood by those skilled in this art that the configuration of the current averaging circuit 20 (AFE circuit 102) that is switchable between the first mode and the second mode is not restricted to such arrangements as described above with reference to FIGS. 4A and 4B.

Returning to FIG. 3, each integrating circuit 30 includes an integrating capacitor C_{INT} and an initializing switch SW3. One end of the integrating capacitor C_{INT} is grounded such that the one end is set to a fixed electric potential. Each integrating capacitor C_{INTi} is charged or discharged according to the differential current received from the corresponding AFE circuit 102.

The initializing switch SW3ᵢ, functions as an initializing circuit that initializes the voltage across the integrating capacitor C_{INT} before the detection. Each initializing switch SW3ᵢ, is arranged such that its one end is coupled to the integrating capacitor C_{INT}, and a buffer (voltage follower) 52 applies a reference voltage V_{CM} to the other end thereof. Each initializing switch SW3ᵢ may be configured as a transfer gate or may be configured as other kinds of switches. When an initializing signal VCM_SW is asserted, the initializing switch SW3ᵢ becomes ON. The reference voltage V_{CM} may be configured as a voltage in the vicinity of the midpoint between the power supply voltage Vdd and the ground voltage Vss, for example.

The multiplexer 40 shown in FIG. 2 is also shown in FIG. 3 as switches SW4₁ through SW4ₙ provided to the respective channels. The A/D converter 50 shown in FIG. 2 is also shown as a pair of separate A/D converters ADC1 and ADC2. The odd-channel detection voltages Vs₁, Vs₃, . . . , are assigned to the A/D converter ADC1, and the even-channel detection voltages Vs₂, Vs₄, . . . , are assigned to the A/D converter ADC2. The outputs of the odd-channel switches SW4₁, SW4₃, . . . , are each coupled to the input of the A/D converter ADC1 such that they are coupled with each other so as to form a common output, and the outputs of the even-channel switches SW4₂, SW4₄, . . . , are each coupled to the input of the A/D converter ADC2 such that they are coupled with each other so as to form another common output. It should be noted that the multiplexer 40 may include a single A/D converter alone. In this case, the detection voltages Vs of all the channels may each be converted into a digital value by means of such a single A/D converter.

The above is a specific configuration of the control IC 4. Next, description will be made regarding the operation thereof.

### [First Mode]

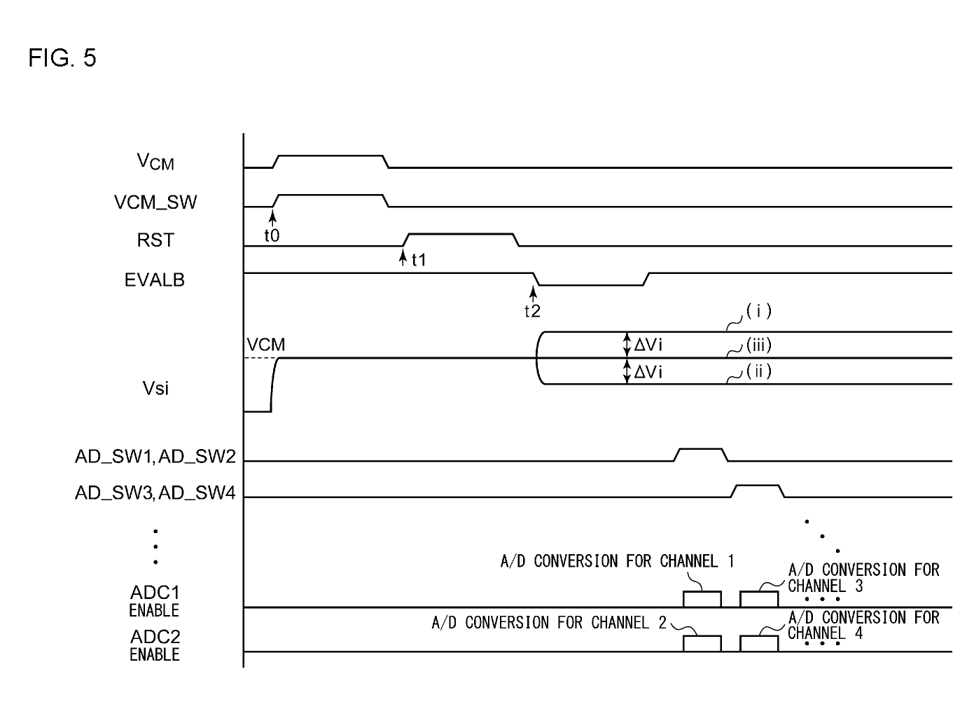

FIG. 5 is a waveform diagram showing the operation of the control IC 4 in the first mode according to the embodiment.

First, the buffer 52 is set to the on state. In this state, the reference voltage V_{CM} is set to a predetermined level. Furthermore, the initializing signal VCM_SW is asserted for all the channels, which turns on the initializing switches SW3₁ through SW3ₙ (time point t0). This initializes the voltage level of each of the integrating capacitors C_{INT1} through C_{INTn} of all the channels to the reference voltage V_{CM}. After the initialization of the integrating capacitors C_{INT} ends, the reference voltage V_{CM} is set to 0 V. In this stage, the initializing signal VCM_SW is negated, which turns off the initializing switches SW3₁ through SW3ₙ.

Subsequently, the reset signal RST is asserted, which turns on the initializing switches SW2₁ through SW2ₙ. This resets the charge of each of the sensor capacitances Cs₁ through Csₙ to zero, i.e., the sensor capacitances Cs₁ through Csₙ are initialized (time point t1). Subsequently, the reset signal RST is negated, which turns off the initializing switches SW2₁ through SW2ₙ.

Subsequently, at time point t₂, the sensing signal EVALB is asserted (set to the low level), which turns on the sensing switches SW1₁ through SW1ₙ.

Description will be made directing attention to the i-th channel. After the sensing switch SW1ᵢ is turned on, a charging current I_{CHGi} flows to the sensor capacitance Csᵢ via the first transistor M1 and the sensing switch SW1, which raises the voltage across the sensor capacitance Csᵢ. When the voltage Vxᵢ across the sensor capacitance Csᵢ rises and reaches (Vdd−Vth), the first transistor M1 is turned off, which stops the charging operation. The voltage Vth matches the gate-source threshold voltage of the first transistor M1. The amount of charge supplied to the sensor capacitance Csᵢ in this charging operation is represented by the following Expression.

Qsᵢ=C·V=Csᵢ×(Vdd−Vth) (3)

The amount of charge supplied to the sensor capacitance Csᵢ in this charging operation depends on the sensor capacitance Csᵢ. That is to say, the charger circuit 10ᵢ supplies the current I_{CHGi} to the sensor capacitance Cs until the voltage across the corresponding sensor capacitance Csᵢ reaches a predetermined level (Vdd−Vth).

The charger circuit 10 duplicates the charging current I_{CHGi} so as to generate a detection current Isᵢ that corresponds to the capacitance value, which charges the integrating capacitor C_{INT}. The detection current Isᵢ is represented by Isᵢ=K1×I_{CHGi}. Accordingly, the amount of charge Q_{INTi} supplied to the integrating capacitor C_{INTi} is represented by the following Expression (4).

Q_{INTi}=Qsᵢ×K1 (4)

The current averaging circuit 20 discharges the integrating capacitor C_{INTi} using the average current I_{AVE} of the detection currents Is₁ through Is of all the channels. The amount of charge Q_{INTAVE} discharged from the integrating capacitor C_{INTi} by means of the current averaging circuit 20 is represented by the following Expression (5).

Q_{INTAVE}=Qs_{AVE}×K1 (5)

Here, Qs_{AVE} represents the average of the amounts of charge supplied to the sensor capacitances Cs₁ through Csₙ of all the channels, which is represented by ΣQsᵢ/n. Furthermore, Qs_{AVE} is represented by the following Expression (6).

Qs_{AVE}=ΣQsᵢ/n=ΣCsᵢ/n×(Vdd−Vth) (6)

When the sensor capacitance Csᵢ is larger than the average Cs_{AVE} of the sensor capacitances Cs₁ through Csₙ of all the channels, the relation Isᵢ>I_{AVE} holds true. In this case, the integrating capacitor C_{INTi} is charged. As a result, the detection voltage Vsᵢ becomes higher by ΔVᵢ than the reference voltage V_{CM} configured as an initial value.

$$\begin{matrix}{ΔV}_{i} = ( {Q}_{INTi} - {Q}_{INTAVE} ) / {C}_{INTi} \\ = ( {Qs}_{i} - {Qs}_{AVE} ) \times K 1 / {C}_{INTi} \\ = ( {Cs}_{i} - {\sum }^{ } {Cs}_{i} / n ) / {C}_{INTi} \times K 1 \times ( Vdd - Vth )\end{matrix} \qquad ( 7 )$$

Conversely, when the sensor capacitance Csᵢ is smaller than the average Cs_{AVE}, i.e., when the relation Qsᵢ<Qs_{AVE} holds true, the relation Isᵢ<I_{AVE} holds true. In this case, the integrating capacitor C_{INTi} is discharged, which lowers the detection voltage Vsᵢ by ΔVᵢ from the reference voltage V_{CM} configured as an initial value.

When the sensor capacitance Csᵢ is equal to the average Cs_{AVE}, i.e., when the relation Qsᵢ=Qs_{AVE} holds true, the relation Isᵢ=I_{AVE} holds true. In this case, there is no change in the amount of charge stored in the integrating capacitor C_{INTi}. That is to say, the relation ΔVᵢ=0 holds true.

Finally, the detection voltage Vsᵢ is represented by the following Expression (8).

$$\begin{matrix}{Vs}_{i} = {V}_{CM} + Δ {V}_{i} \\ = {V}_{CM} + ( {Cs}_{i} - {\sum }^{ } {Cs}_{i} / n ) / {C}_{INTi} \times K 1 \times ( Vdd - Vth )\end{matrix} \qquad ( 8 )$$

As described above, the changes in capacitance of the sensor capacitances Cs₁ through Csₙ of all the channels are converted into the detection voltages Vs₁ through Vsₙ, respectively, which are held by the integrating capacitors C_{INT1} through C_{INTn}, respectively.

Subsequently, the switches SW4₁ through SW4ₙ are controlled according to an appropriate sequence, so as to instruct the pair of A/D converters ADC1 and ADC2 to convert the detection voltages Vs₁ through Vsₙ of all the channels into digital values.

In the first mode, such an arrangement is capable of detecting the electrostatic capacitance of each channel in the form of a relative change in the capacitance. This provides improved noise resistance.

### [Second Mode]

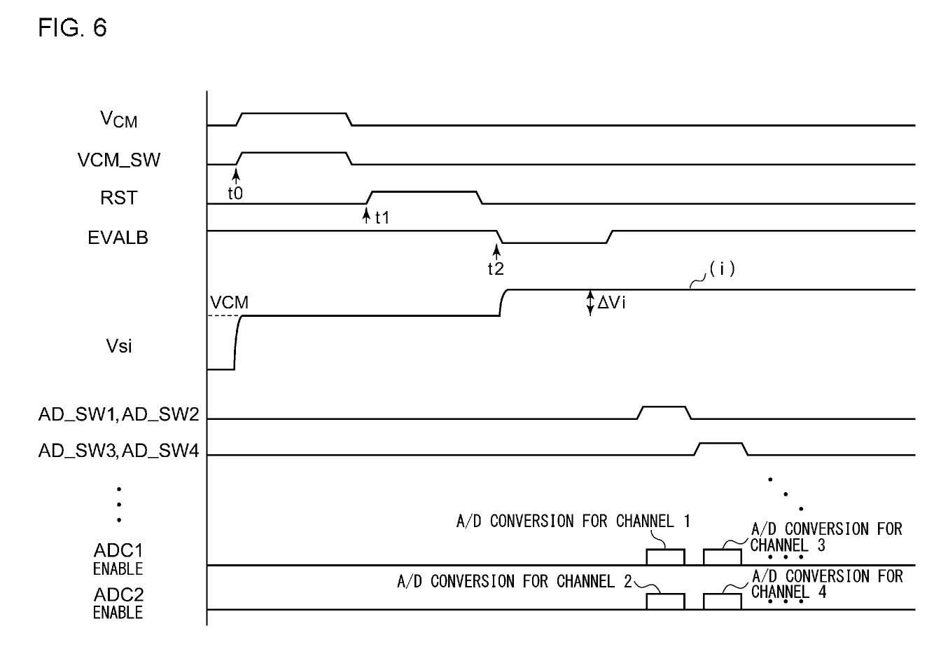

FIG. 6 is a waveform diagram showing the operation of the control IC 4 according to the embodiment. Before the time point t2, the operation in the second mode is the same as that in the first mode. At the time point t2, the sensing signal EVALB is asserted (set to the low level), which turns on the sensing switch SW1₁ through SW1ₙ.

Description will be made directing attention to the i-th channel. After the sensing switch SW1ᵢ is turned on, a charging current I_{CHGi} flows to the sensor capacitance Csᵢ via the first transistor M1 and the sensing switch SW1, which raises the voltage across the sensor capacitance Csᵢ. When the voltage Vxᵢ across the sensor capacitance Csᵢ rises and reaches (Vdd−Vth), the first transistor M1 is turned off, which stops the charging operation. The voltage Vth matches the gate-source threshold voltage of the first transistor M1. The amount of charge supplied to the sensor capacitance Csᵢ in this charging operation is represented by the following Expression.

Qsᵢ=C·V=Csᵢ×(Vdd−Vth) (3)

The charger circuit 10 duplicates the charging current I_{CHGi} so as to generate a detection current Isᵢ that corresponds to the capacitance value, which charges the integrating capacitor C_{INT}. The detection current Isᵢ is represented by Isᵢ=K1×I_{CHGi}. Accordingly, the amount of charge Q_{INTi} supplied to the integrating capacitor C_{INTi} is represented by the following Expression (4).

Q_{INTi}=Qsᵢ×K1 (4)

As a result, the detection voltage Vsᵢ becomes higher by ΔVᵢ than the reference voltage V_{CM} configured as an initial value.

$$\begin{matrix}{ΔV}_{i} = {Q}_{INTi} / {C}_{INTi} \\ = {Qs}_{i} \times K 1 / {C}_{INTi} \\ = {Cs}_{i} / {C}_{INTi} \times K 1 \times ( Vdd - Vth )\end{matrix} \qquad ( 8 )$$

In the second mode, such an arrangement is capable of detecting the electrostatic capacitance of each channel in the form of an absolute value of the capacitance. Thus, such an arrangement allows an abnormal state and deviation of the overall capacitance (drift) to be detected. The result of detection of such capacitance drift may be employed as an indicator for variation due to change in temperature, and for aging degradation.

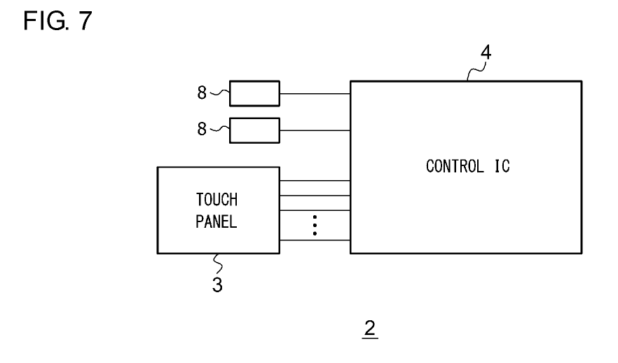

FIG. 7 is a circuit diagram showing an application of the input apparatus 2 including the control IC 4 according to the embodiment. The control IC 4 is coupled to at least one electrostatic switch 8, in addition to the touch panel 3. The operation in the first mode requires that the multiple sensor capacitances Cs have a uniform sensor capacitance Cs. Accordingly, it is difficult for operation in the first mode to measure the capacitance of another such electrostatic switch 8 having a different structure and a different size.

In order to solve such a problem, the channels coupled to the touch panel 3 are operated in the first mode (or otherwise the second mode), and the channels coupled to the electrostatic switches 8 are operated in the second mode. Such an operation allows such a single control IC 4 to perform sensing for both the electrostatic switches 8 and the touch panel 3.

It should be noted that, in a case in which the number of the electrostatic switches 8 is great, and such electrostatic switches 8 have uniform characteristics, the channels coupled to the electrostatic switches 8 may be operated in the first mode.

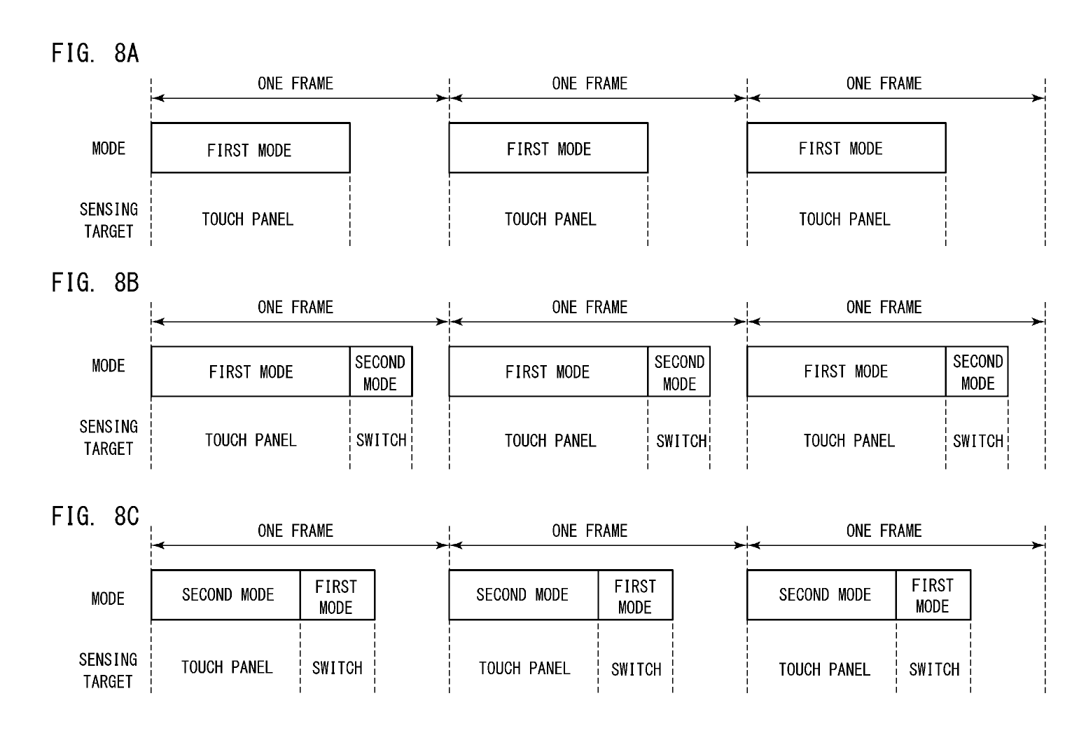

FIGS. 8A through 8C are operation waveform diagrams showing the operation of the input apparatus 2 shown in FIG. 7. FIG. 8A shows an operation in which sensing is performed with only the touch panel 3 in the first mode. FIGS. 8B and 8C each show an operation in which the sensing of the touch panel 3 and the sensing of the electrostatic switches 8 is performed in each frame in a time sharing manner. Specifically, in the sequence shown in FIG. 8B, sensing is performed with the touch panel 3 in the first mode and with the electrostatic switches 8 in the second mode.

FIG. 8C shows a sequence in which sensing is performed with the touch panel 3 in the second mode and with the electrostatic switches 8 in the first mode. The sequence shown in FIG. 8C is effectively applicable to an arrangement in which the touch panel 3 has a small capacitance, and the electrostatic switches 8 involve a great number of channels.

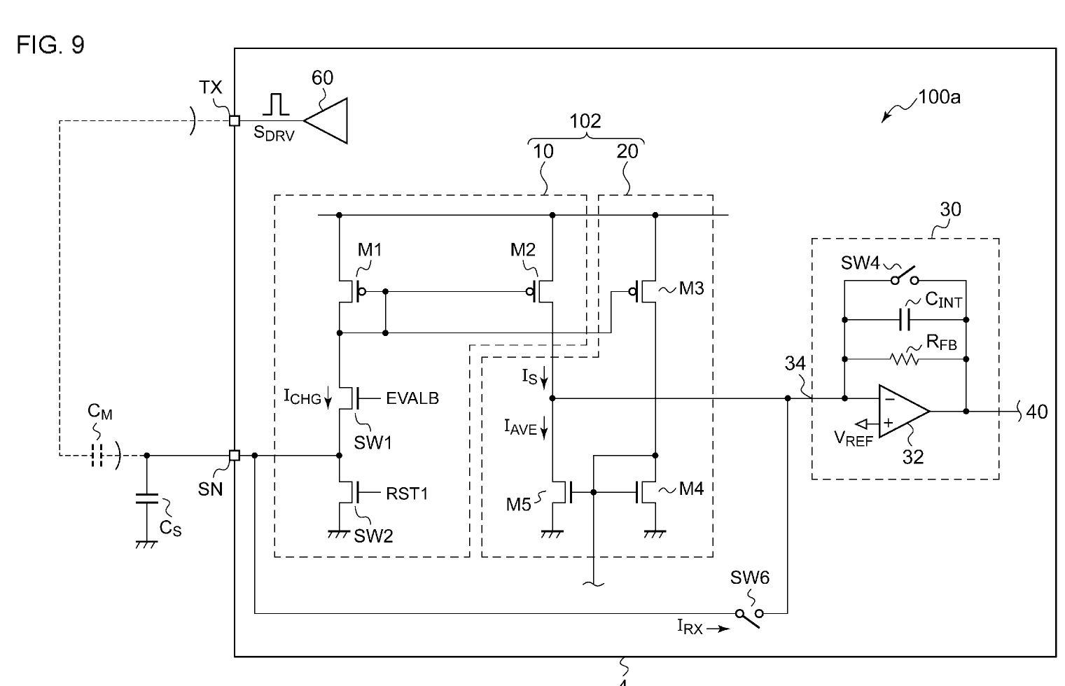

FIG. 9 is a circuit diagram showing a modification (100a) of the capacitance measurement circuit 100. FIG. 9 shows a single-channel configuration. The capacitance measurement circuit 100a is configured to be switchable between the aforementioned self-capacitance method and a mutual-capacitance method. In the first mode or otherwise the second mode, the capacitance measurement circuit 100a measures the self capacitance Cs. In the third mode, the capacitance measurement circuit 100a measures the mutual capacitance C_{M}.

The self-capacitance method has advantages of low power consumption and high sensitivity. In contrast, the mutual-capacitance method has an advantage of allowing multi-touch detection. Accordingly, before the user starts a touch operation (standby state), the first mode is selected, so as to detect a touch operation via a finger (stylus). After a touch operation is detected, the detection mode is switched to the second mode, which allows various kinds of input operations to be detected.

A sensing terminal SN is coupled to an electrostatic capacitance to be measured. In order to support the self-capacitance method, the charger circuit 10 and the integrating circuit 30 are provided. In the first mode or otherwise the second mode, which corresponds to the self-capacitance method, the charger circuit 10 is set to an active state. In the first mode, the current averaging circuit 20 is set to an active state. On the other hand, in the second mode, the current averaging circuit 20 is set to an inactive state.

The charger circuit 10 applies a fixed voltage (e.g., the power supply voltage V_{DD}) to the self capacitance Cs, so as to charge the self capacitance Cs. In this charging operation, the detection current I_{S} is generated according to the charging current I_{CHG}. The difference between the detection current I_{S} and the average current I_{AVE} is input to the integrating circuit 30 configured as a downstream stage.

In the first mode or otherwise the second mode, the integrating circuit 30 integrates the difference in the current I_{S} generated by the charger circuit 10 in the sensing period and the current I_{AVE} generated by the current averaging circuit 20, i.e., integrates the differential current (I_{S}−I_{AVE}), so as to generate the detection voltage V_{S} that corresponds to the integrated value.

In order to support the mutual capacitance method, a bypass switch SW6, the integrating circuit 30, a transmitter 60, and a transmission (TX) terminal are provided. The TX terminal is coupled to one end of a mutual capacitance C_{M}. The transmitter 60 generates a pulse-shaped driving signal S_{DRV}, and supplies the driving signal S_{DRV} thus generated to one end of the mutual capacitance C_{M}.

For example, the integrating circuit 30 includes an operational amplifier 32, an integrating capacitor C_{INT}, a feedback resistor R_{FB}, and a fourth switch SW4. The integrating capacitor C_{INT} is arranged between the output terminal and the inverting input terminal of the operational amplifier 32. The feedback resistor R_{FB} is coupled in parallel with the integrating capacitor C_{INT}. The fourth switch SW4 is arranged in parallel with the integrating capacitor C_{INT} in order to allow the charge stored in the integrating capacitor C_{INT} to be initialized (discharged). Before the sensing period, the fourth switch SW4 is turned on. During the sensing period, the fourth switch SW4 is turned off.

The bypass switch SW6 is arranged such that its one end is coupled to the sensing terminal SN. In the first mode or otherwise the second mode, the bypass switch SW6 is turned off. In the third mode, the bypass switch SW6 is turned on. An input terminal 34 of the integrating circuit 30 is coupled to the other end of the bypass switch SW6 in addition to the second transistor M2 of the charger circuit 10. In the third mode, a received current I_{RX} that corresponds to the mutual capacitance C_{M} flows into the input terminal 34 via the mutual capacitance C_{M} and the bypass switch SW6. In the third mode, the integrating circuit 30 integrates the received current I_{RX} so as to generate the detection voltage V_{S}.

Furthermore, the A/D converter 50 is provided as a downstream stage of the integrating circuit 30. However, the A/D converter 50 is not shown in FIG. 9. Next, description will be made regarding the operation thereof.

### [First Mode and Second Mode] Self-Capacitance Method

The operations in the first mode and the operation in the second mode are performed in the same way as described above.

### [Third Mode] Mutual Capacitance Method

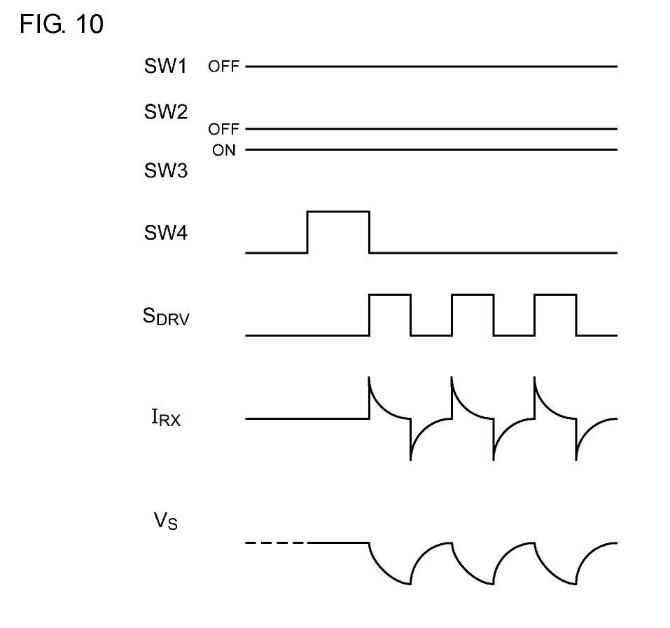

FIG. 10 is an operation waveform diagram showing the operation of the capacitance measurement circuit 100 in the third mode. In the third mode, the initializing switch SW2 is turned off, and the bypass switch SW6 is turned on.

Before the sensing period, the fourth switch SW4 is turned on, which initializes the charge stored in the integrating capacitor C_{INT}. As a result, the detection voltage V_{S} becomes equal to the reference voltage V_{REF}. In the subsequent sensing period, the driving signal S_{DRV} is supplied to the mutual capacitance C_{M}, which generates the flow of the received current I_{RX}. The integrating capacitor C_{INT} is charged (or discharged) using the received current I_{RX}, which generates the detection voltage V_{S}.

The above is the operation of the capacitance measurement circuit 100a. The capacitance measurement circuit 100a requires only such a single integrating circuit 30 to support both a function of converting the detection current I_{S} into the voltage V_{S} in the self-capacitance method and a function of integrating the received current I_{RX} in the mutual-capacitance method. This allows the circuit area to be reduced.

The above is the configuration of the input apparatus 2. The input apparatus 2 is capable of detecting, based on the relative changes of the multiple self-capacitances Cs₁ through Csₙ, the coordinate position at which the user operates the input apparatus 2 by touch or otherwise by proximity with a finger or stylus.

Description has been made above regarding the present invention with reference to the embodiment. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

### [First Modification]

Description has been made in the embodiment regarding an example in which the sensor capacitances Cs are substantially arranged in a matrix form. However, the usage of the capacitance measurement circuit 100 is not restricted to such an arrangement. For example, the capacitance measurement circuit 100 is applicable to an X-Y-type touch panel. In this case, such an arrangement is capable of detecting the electrostatic capacitances of multiple row sensor electrodes and the electrostatic capacitances of multiple column sensor electrodes at the same time.

### [Second Modification]

The capacitance measurement circuit 100 described in the embodiment may be electrically reversed. It can clearly be understood that, in order to provide such a modification, each P-channel MOSFET and each N-channel MOSFET may be exchanged as appropriate. In this modification, the charging operation and the discharging operation are also exchanged. However, such a modification provides substantially the same operation. Also, a part of the transistors may be substituted by bipolar transistors.

### [Third Modification]

Description has been made in the embodiment regarding an arrangement in which the capacitance measurement circuit 100 is applied to an input apparatus employing a change in the electrostatic capacitance. However, the usage of the capacitance measurement circuit 100 is not restricted to such an arrangement. For example, the capacitance measurement circuit 100 is also applicable to a microphone including a diaphragm electrode and a back plate electrode structured to form a capacitor having an electrostatic capacitance that changes according to sound pressure.

### [Fourth Modification]

Description has been made in the embodiment regarding an arrangement in which the capacitance measurement circuit 100 is monolithically integrated on a single semiconductor circuit. However, the present invention is not restricted to such an arrangement. Also, each circuit block may be configured including chip components or discrete elements. With such a modification, judgement of whether or not each block is to be integrated may be made based on costs, required characteristics, or the like.

While the preferred embodiments of the present invention have been described using specific terms, such description is for illustrative purposes only, and it is to be understood that changes and variations may be made without departing from the spirit or scope of the appended claims.

What is claimed is:

1. A capacitance measurement circuit structured to measure a plurality of electrostatic capacitances, the capacitance measurement circuit comprising a plurality of analog frontend circuits, wherein each of the plurality of analog frontend circuits comprises:
a sensing terminal to be coupled to a corresponding electrostatic capacitance;
a first transistor arranged between the corresponding electrostatic capacitance and a first fixed voltage line;
a second transistor and a third transistor coupled so as to form, together with the first transistor, a first current mirror circuit;
a fourth transistor arranged between the third transistor and a second fixed voltage line; and
a fifth transistor coupled between the second transistor and the second fixed voltage line so as to form, together with the fourth transistor, a second current mirror,
wherein each of the analog frontend circuits is structured to generate a signal that corresponds to a difference between a current that flows through the first transistor and a current that flows through the fifth transistor,
wherein control terminals of the fourth transistors and control terminals of the fifth transistors of the plurality of analog frontend circuits are coupled together so as to form a common control terminal,
and wherein an operation mode is switchable between: (i) a first mode in which a current flows through each of the first transistor through the fifth transistor; and (ii) a second mode in which a current flows through each of the first transistor and the second transistor, and no current flows through the fifth transistor.

2. The capacitance measurement circuit according to claim 1, wherein each of the analog frontend circuits further comprises a first mode switch arranged in parallel with the fourth transistor.

3. The capacitance measurement circuit according to claim 1, wherein each of the analog frontend circuits further comprises a second mode switch arranged between the second fixed voltage line and the common control terminal of the fourth transistor and the fifth transistor.

4. The capacitance measurement circuit according to claim 1, wherein each of the analog frontend circuits further comprises:
a third mode switch arranged between a common control terminal of the first transistor and the second transistor and a control terminal of the third transistor; and
a fourth mode switch arranged between the control terminal of the third transistor and the first fixed voltage line.

5. The capacitance measurement circuit according to claim 1, wherein each of the analog frontend circuits further comprises:
a sensing switch structured to switch, between an on state and an off state, a charging operation of the first transistor for charging the electrostatic capacitance; and
an initializing switch arranged between the sensing terminal and the second fixed voltage line.

6. The capacitance measurement circuit according to claim 5, wherein the sensing switch is arranged in series with the first transistor between the sensing terminal and the first fixed voltage line.

7. The capacitance measurement circuit according to claim 1, wherein each of the analog frontend circuits further comprises:
a bypass switch having one end coupled to the sensing terminal; and
an integrating circuit having an input terminal coupled to the second transistor and the other end of the bypass switch, and structured to integrate a current input via the input terminal so as to generate a detection voltage.

8. The capacitance measurement circuit according to claim 7, wherein the integrating circuit comprises:
an operational amplifier;
an integrating capacitor arranged between an output terminal and an inverting input terminal of the operational amplifier; and
a feedback resistor coupled in parallel with the integrating capacitor.

9. A capacitance measurement circuit structured to measure a plurality of electrostatic capacitances, the capacitance measurement circuit comprising:
a plurality of charger circuits that are respectively associated with the plurality of electrostatic capacitances, and each of which is structured to charge the corresponding electrostatic capacitance so as to generate a detection current that corresponds to a charging current; and
a current averaging circuit structured to be switchable between: an on state in which the current averaging circuit outputs an average current obtained by averaging the detection currents generated by the plurality of charger circuits; and an off state in which the current averaging circuit outputs an average current of zero,
wherein each electrostatic capacitance is measured based on a differential current between the corresponding detection current and the average current.

10. The capacitance measurement circuit according to claim 9, wherein the charger circuit comprises:
a reset switch structured to initialize a charge stored in the corresponding electrostatic capacitance;
a sensing switch and a first transistor configured as a MOSFET, which are sequentially arranged in series between the corresponding electrostatic capacitance and a fixed voltage terminal; and
a second transistor coupled to the first transistor so as to form a first current mirror circuit,
wherein a current that flows through the second transistor is output as the detection current that corresponds to the corresponding electrostatic capacitance.

11. The capacitance measurement circuit according to claim 10, wherein the current averaging circuit comprises:
a plurality of third transistors that are respectively associated with the plurality of electrostatic capacitances, and each of which is coupled to a corresponding first transistor so as to form a current mirror circuit;
a plurality of fourth transistors that are respectively associated with the plurality of electrostatic capacitances, and that have control terminals coupled together so as to form a common control terminal, and each of which is arranged in series with a corresponding third transistor; and
a plurality of fifth transistors that are respectively associated with the plurality of electrostatic capacitances, and each of which is coupled to a corresponding fourth transistor so as to form a current mirror circuit,
and wherein currents that flows through the plurality of fifth transistors are each output as the average current.

12. The capacitance measurement circuit according to claim 11, further comprising a plurality of first mode switches that are respectively associated with the plurality of electrostatic capacitances, and each of which is coupled in parallel with a corresponding fourth transistor.

13. The capacitance measurement circuit according to claim 11, further comprising a plurality of second mode switches that are respectively associated with the plurality of electrostatic capacitances, and each of which is arranged between a gate of the corresponding fourth transistor and a ground.

14. The capacitance measurement circuit according to claim 11, wherein the current averaging circuit comprises:
a plurality of third mode switches that are respectively associated with the plurality of electrostatic capacitances, and each of which is arranged between a common control terminal of the corresponding first transistor and the corresponding second transistor and a control terminal of the corresponding third transistor; and
a plurality of fourth mode switches that are respectively associated with the plurality of electrostatic capacitances, and each of which is arranged between the control terminal of the corresponding third transistor and a power supply line.

15. The capacitance measurement circuit according to claim 11, wherein each of the plurality of fifth transistors has one end coupled to one terminal of the corresponding second transistor,
and wherein a difference between a current that flows through the second transistor and a current that flows through the fifth transistor is output.

16. The capacitance measurement circuit according to claim 1, monolithically integrated on a single semiconductor substrate.

17. An input apparatus comprising:
a touch panel comprising a plurality of sensor electrodes structured such that electrostatic capacitances thereof change in the vicinity of a coordinate position at which a user touches the touch panel; and
the capacitance measurement circuit according to claim 1, structured to measure the plurality of electrostatic capacitances formed by the plurality of sensor electrodes.

18. An electronic device comprising the input apparatus according to claim 17.
